(19) United States
(12) Patent Application Publication
(10) Pub. No.: US 2026/0301211 A1
(43) Pub. Date: Oct. 1, 2026

(54) SYSTEMS AND METHODS FOR PERFORMING TRAILER COUPLER LOCATION APPROXIMATION USING TRAILER JACKSTAND

(71) Applicants: Hyundai Motor Company, Seoul (KR); Kia Corporation, Seoul (KR)

(72) Inventors: Ehsan Arabi, Superior Township, MI (US); Erol Dogan Sumer, Superior Township, MI (US); Enrique Corona, Superior Township, MI (US)

(21) Appl. No.: 19/094,536

(22) Filed: Mar. 28, 2025

(51) Int. Cl. G06T 7/70; B60R 1/00; B60R 1/26; B60W 60/00; B62D 13/06; G06T 7/60

(52) U.S. Cl. CPC G06T 7/70; B60R 1/003; B60R 1/26; B60W 60/001; B62D 13/06; G06T 7/60; B60W 2300/14; B60W 2420/403; G06T 2207/30252

(57) ABSTRACT

Systems and methods for performing trailer coupler location approximation are provided. In one aspect, the method may comprise: i) identifying a jackstand and coupler frame of a trailer within an image; ii) determining a path target point based on image; and iii) constructing a path from a hitch of a vehicle to the path target point.

### BACKGROUND

### Technical Field

Embodiments of the present disclosure relate to systems and methods for performing trailer coupler location approximation using a trailer jackstand.

### Background

Some modern vehicles are equipped with a smart hitch assist function, or autohitch, which enables a vehicle to automatically back up and attach to a trailer. This process relies on a perception system to identify the trailer's coupler via the vehicle's rear-view camera, enabling precise vehicle alignment and hitching without manual intervention.

Trailer coupler detection is crucial for the autohitch functionality. However, coupler detection can be a challenge due to its small size, especially at far distances. The perception system may additionally detect a trailer front, a trailer bottom, a coupler frame, and a jackstand (see, e.g., FIG. 1). Therefore, at far distances in which the coupler is not detectable, a centroid of the trailer front, the trailer bottom, and the coupler frame may be used for path planning and control.

The location of the coupler within the coupler frame bounding box changes based on the rear-view camera angle with respect to the trailer, which can be interpreted as the relative heading angle between the vehicle and the trailer. Therefore, using the centroid of the other bounding boxes (trailer front, trailer bottom, and coupler frame) may introduce large errors into the autohitch function. As a result, at the final stages of an autohitch maneuver, when the coupler becomes detectable, the system must compensate for these large errors.

With limitations on steering and the short distance left to the coupler, these correction maneuvers could become extremely difficult and the system may fail to complete the hitching maneuver.

### SUMMARY

We now provide new methods for determining and performing trailer coupler location approximation.

According to an object of the present disclosure, a method for performing trailer coupler location approximation is provided.

Among other things, we have found that identifying a jackstand in the location process can provide an enhanced and facilitated coupling of a trailer. In aspects, the present methods and system include a detected jackstand and coupler frame to approximate the location of the coupler. The approximated coupler location can be then used for path planning and control purposes at extended distances where the detection of the coupler is inhibited or not possible e.g. due to its small size. This can result in better alignment of the vehicle with the coupler at final stages of the hitching maneuver.

In one aspect, the method comprises:
i) identifying a jackstand and coupler frame of a trailer within an image;
ii) determining a path target point based on the image; and
iii) constructing a path from a hitch of a vehicle to the path target point. The identifying, determining and/or constructing may include using a computing device comprising a processor and a memory.

In a preferred aspect, the method may comprise:
a) identifying, using a computing device comprising a processor and a memory, a jackstand and coupler frame of a trailer within an image;
b) defining a bounding box for the jackstand and a bounding box for the coupler frame;
c) setting an intersection between the bounding box for the jackstand and the bounding box for the coupler frame as a starting point for an approximation bounding box for a trailer coupler;
setting a centroid of the approximation bounding box for the trailer coupler as a path target point; and
e) constructing a path from a hitch of a vehicle to the path target point.

According to an exemplary embodiment, the method may comprise, prior to setting the centroid of the approximation bounding box for the trailer coupler as the path starting point, calculating dimensions of the approximation bounding box for the trailer coupler with respect to the bounding box for the coupler frame.

In a further aspect, the method may comprise:
a) identifying, using a computing device comprising a processor and a memory, a jackstand and coupler frame of a trailer;
b) defining a bounding box for the jackstand and a bounding box for the coupler frame;
c) determining whether there is an intersection between the bounding box for the jackstand and the bounding box for the coupler frame;
d) when there is an intersection between the bounding box for the jackstand and the bounding box for the coupler frame, finding the intersection between the bounding box for the jackstand and the bounding box for the coupler frame;
setting the intersection as a starting point for an approximation bounding box for a trailer coupler;
f) calculating dimensions of the approximation bounding box for the trailer coupler with respect to the bounding box for the coupler frame;
g) setting a centroid of the approximation bounding box for the trailer coupler as a path target point; and
h) constructing a path from a hitch of a vehicle to the path target point.

According to an embodiment, identifying a jackstand and coupler frame of a trailer may be within an image, e.g. provided by an imaging device such as a rear-view camera. In an aspect, the identifying the jackstand and coupler frame within the image may comprise capturing the image, using a rear-view camera of the vehicle.

In an aspect, the dimensions calculated may be a width and a height of the approximation bounding box for the trailer coupler with respect to the bounding box for the coupler frame.

According to an exemplary embodiment, the present methods may comprise performing an autonomous vehicle (AV) maneuver according to the path, comprising automatically executing acceleration and steering maneuvers to cause the vehicle to adhere to the path.

According to an exemplary embodiment, the present methods may comprise, after performing the AV maneuver, determining whether the hitch is positioned within a predefined error distance threshold from the trailer coupler.

According to an exemplary embodiment, the intersection may comprise an intersection area, and the starting point may comprise a centroid of the intersection area.

According to an exemplary embodiment, the intersection may comprise an intersection line, and the starting point may comprise a middle point of the intersection line.

According to an exemplary embodiment, the present methods may comprise, when there is not an intersection between the bounding box for the jackstand and the bounding box for the coupler frame, determining whether the jackstand is positioned under the coupler frame.

According to an exemplary embodiment, the present methods may comprise, when there is not an intersection between the bounding box for the jackstand and the bounding box for the coupler frame and the jackstand is under the coupler frame, extending the bounding box of the jackstand vertically until the bounding box for the jackstand reaches the bounding box of the coupler frame.

According to an exemplary embodiment, the identifying the jackstand and coupler frame within an image may comprise determining a relative position of the one or more trailer components to the hitch.

According to an exemplary embodiment, the identifying the jackstand and coupler frame within an image may comprise determining whether the jackstand has been detected within the image, and determining whether the coupler frame has been detected within the image.

In further aspects, a system for performing trailer coupler location approximation is provided. The system may comprise a vehicle. The vehicle may comprise a rear-view camera, a hitch, and a computing device, comprising a processor and a memory. The memory may be configured to store instructions that, when executed by the processor, are configured to cause the processor to: i) identify a jackstand and coupler frame of a trailer within an image; ii) determine a path target point based on image; and iii) construct a path from a hitch of a vehicle to the path target point.

In further aspects, a system for performing trailer coupler location approximation is provided. The system may comprise a vehicle. The vehicle may comprise a rear-view camera, a hitch, and a computing device, comprising a processor and a memory. The memory may be configured to store instructions that, when executed by the processor, are configured to cause the processor to: a) identify a jackstand and coupler frame of a trailer within an image; b) define a bounding box for the jackstand and a bounding box for the coupler frame; c) set an intersection between the bounding box for the jackstand and the bounding box for the coupler frame as a starting point for an approximation bounding box for a trailer coupler; d) set a centroid of the approximation bounding box for the trailer coupler as a path target point; and e) construct a path from a hitch of a vehicle to the path target point.

In further aspects, a system for performing trailer coupler location approximation is provided. The system may comprise a vehicle. The vehicle may comprise a rear-view camera, a hitch, and a computing device, comprising a processor and a memory. The memory may be configured to store instructions that, when executed by the processor, are configured to cause the processor to: a) identify a jackstand and coupler frame of a trailer within an image; b) define a bounding box for the jackstand and a bounding box for the coupler frame; c) determine whether there is an intersection between the bounding box for the jackstand and the bounding box for the coupler frame; d) when there is an intersection between the bounding box for the jackstand and the bounding box for the coupler frame, find the intersection between the bounding box for the jackstand and the bounding box for the coupler frame; e) set the intersection as a starting point for a an approximation bounding box for a trailer coupler; f) calculate a width and a height of the approximation bounding box for the trailer coupler with respect to the bounding box for the coupler frame g) set a centroid of the approximation bounding box for the trailer coupler as a path target point; and h) construct a path from a hitch of a vehicle to the path target point.

According to an exemplary embodiment, the instructions, when executed by the processor, may be configured to cause the processor to perform an autonomous vehicle (AV) maneuver according to the path, comprising automatically executing acceleration and steering maneuvers to cause the vehicle to adhere to the path.

According to an exemplary embodiment, the instructions, when executed by the processor, may be configured to cause the processor to, after performing the AV maneuver, determine whether the hitch is positioned within a predefined error distance threshold from the trailer coupler.

According to an exemplary embodiment, the intersection may comprise an intersection area, and the starting point may comprise a centroid of the intersection area.

According to an exemplary embodiment, the intersection may comprise an intersection line, and the starting point may comprise a middle point of the intersection line.

According to an exemplary embodiment, the instructions, when executed by the processor, may be configured to cause the processor to, when there is not an intersection between the bounding box for the jackstand and the bounding box for the coupler frame, determine whether the jackstand is positioned under the coupler frame.

According to an exemplary embodiment, the instructions, when executed by the processor, may be configured to cause the processor to, when there is not an intersection between the bounding box for the jackstand and the bounding box for the coupler frame and the jackstand is under the coupler frame, extend the bounding box of the jackstand vertically until the bounding box for the jackstand reaches the bounding box of the coupler frame.

According to an exemplary embodiment, the identifying the jackstand and coupler frame within an image may comprise capturing the image, using a rear-view camera of the vehicle.

According to an exemplary embodiment, the identifying the jackstand and coupler frame may comprise determining a relative position of the one or more trailer components to the hitch.

According to an exemplary embodiment, the identifying the jackstand and coupler frame within an image may comprise determining whether the jackstand has been detected within the image, and determining whether the coupler frame has been detected within the image.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a view of a trailer having a trailer front, a trailer bottom, a trailer coupler frame, and a jackstand, according to an exemplary embodiment of the present disclosure.

FIG. 2 illustrates an example a system for performing trailer coupler location approximation using a trailer jackstand, according to an exemplary embodiment of the present disclosure.

FIGS. 3A-3B illustrates a block/flow diagram of a method for performing trailer coupler location approximation using a trailer jackstand, according to an exemplary embodiment of the present disclosure.

FIG. 4 illustrates a trailer coupler frame bounding box and a jackstand bounding box, according to an exemplary embodiment of the present disclosure.

FIG. 5 illustrates an example architecture of a vehicle, according to an exemplary embodiment of the present disclosure.

FIG. 6 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for performing trailer coupler location approximation using a trailer jackstand are provided.

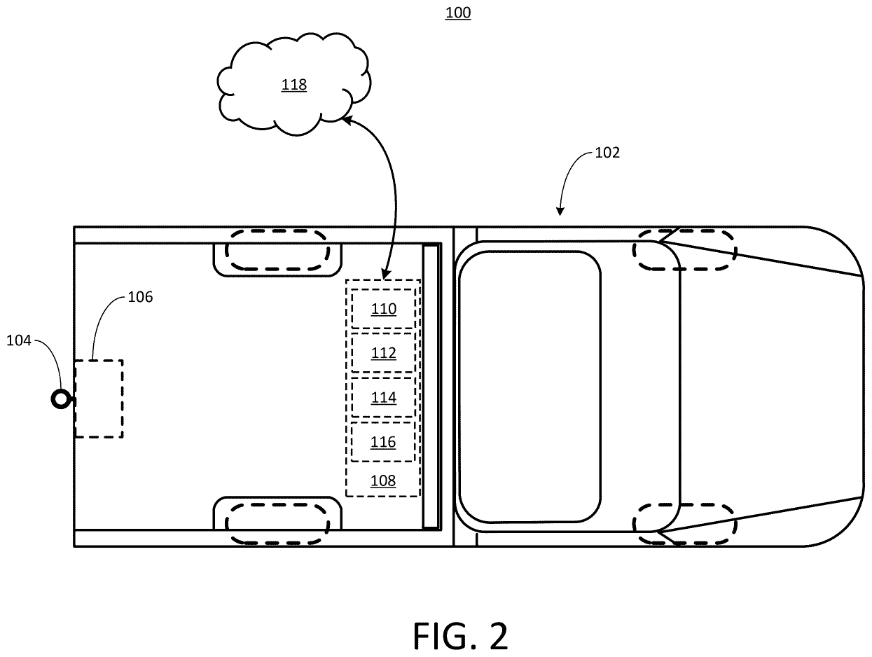

Referring now to FIG. 2, a system 100 for performing trailer coupler location approximation using a trailer jackstand is illustratively depicted, in accordance with an exemplary embodiment of the present disclosure.

According to an exemplary embodiment, the system 100 may comprise a vehicle 102. The vehicle 102 may comprise a pickup truck, van, and/or other suitable vehicle. According to an exemplary embodiment, the vehicle 102 may comprise a towing vehicle. The vehicle 102 may comprise a hitch 104 configured to connect to a coupler of a trailer or other suitable towable vehicle.

According to an exemplary embodiment, the vehicle 102 may comprise a computing device 108. The computing device 108 may comprise a processor 110, a memory 112, a user interface 114 (e.g., a graphical user interface), a transmitter/transceiver 116, and/or other suitable components. The computing device 108 may be configured to send and/or receive commands/data/input/etc. via one or more external systems via wired and/or wireless connection (e.g., via the cloud 118).

According to an exemplary embodiment, the vehicle 102 may comprise a rear-view camera 106. According to an exemplary embodiment, the rear-view camera 106 may be configured to communicate with and/or is coupled to the computing device 108.

According to an exemplary embodiment, the vehicle's 102 hitch 104 may be configured to couple to a trailer's coupler to tow the trailer. In order to connect the hitch 104 to the trailer coupler, the towing vehicle 102 is typically steered and driven to a correct location wherein the hitch 104 is in place to connect to the trailer coupler. The driving of the towing vehicle 102 to the trailer coupler may be automated. Automated hitching may use the trailer coupler as a path target point. The small size of the trailer coupler makes detection difficult at far distances. Larger trailer structures (e.g., the trailer front, trailer bottom, coupler frame, etc.) are detectable at farther distances and are often used to approximate a location of the trailer coupler until the trailer coupler can be detected. However, the positions of the larger trailer structures may not correspond with the position of the trailer coupler.

According to an exemplary embodiment, the system 100 may be configured to detect one or more components of a trailer. The one or more components may comprise a trailer coupler, a trailer front, a trailer bottom, a coupler frame, a jackstand, and/or other suitable components.

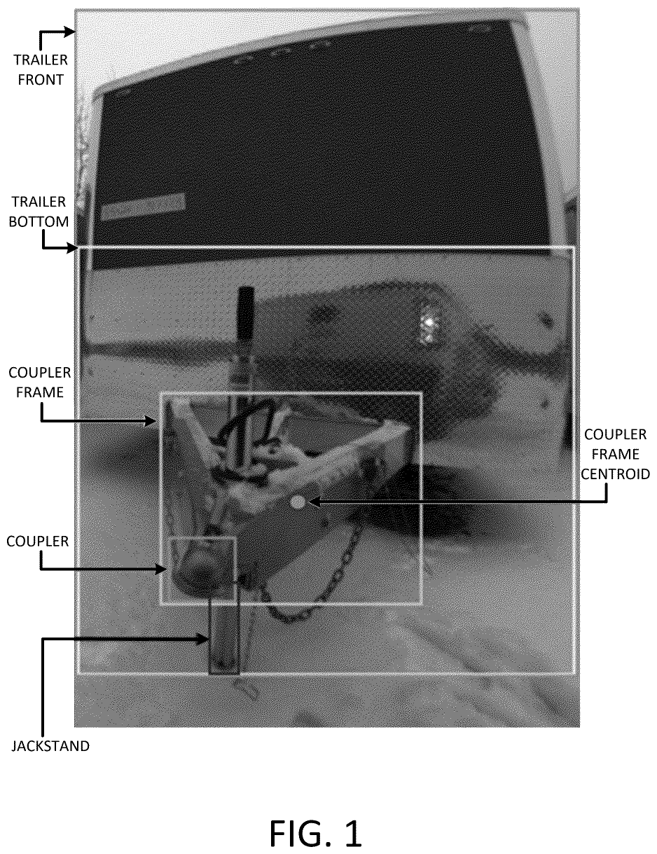

As shown in FIG. 1, on a trailer, a jackstand is often located underneath a coupler frame and several inches behind the trailer coupler. Therefore, when viewed from the towing vehicle's 102 rear-view camera 106, the intersection of a jackstand bounding box and a trailer coupler frame bounding box may also intersect with a trailer coupler bounding box. According to an exemplary embodiment, the detected jackstand and coupler frame may be leveraged to approximate a location of the coupler.

According to an exemplary embodiment, the approximated coupler location may then be used for path planning and control purposes at far distances, where the detection of the coupler is not possible due to its small size. This results in better alignment of the vehicle with the coupler at final stages of a hitching maneuver.

The memory 112 may be configured to store programming instructions that, when executed by the processor 110, may be configured to cause the processor 110 to perform one or more tasks such as, e.g., defining jackstand and coupler frame bounding boxes, finding an intersection between the jackstand and coupler frame bounding boxes, setting the intersection as a starting point for a trailer coupler approximation bounding box, calculating width and height of the trailer coupler approximation bounding box with respect to the coupler frame bounding box, setting a centroid of the approximated trailer coupler bounding box as path target point, and/or performing one or more other suitable tasks. According to an exemplary embodiment, the intersection may comprise an area and the starting point is a centroid of the intersection area. According to an exemplary embodiment, the intersection may comprise a line and the starting point is a middle point of the intersection line.

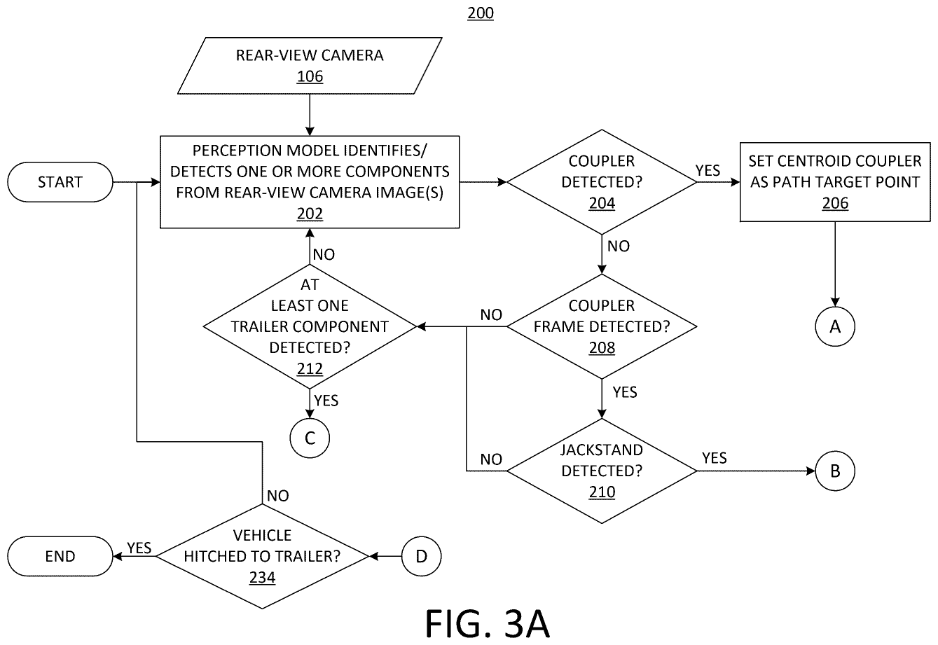

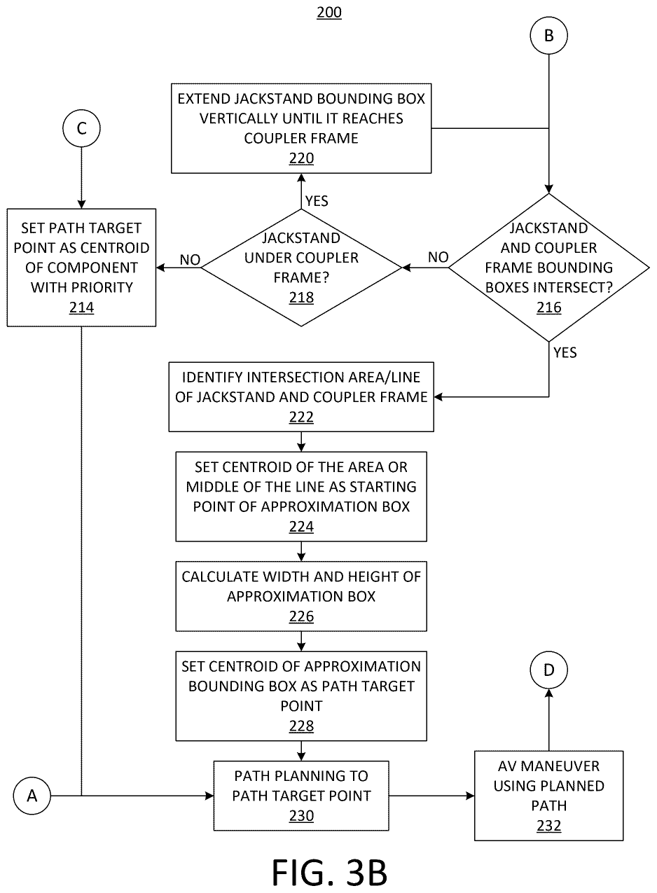

Referring now to FIGS. 3A-3B, a block/flow diagram of a method 200 for performing trailer coupler location approximation using a trailer jackstand is illustratively depicted, in accordance with an exemplary embodiment of the present disclosure.

At 202, a perception model may utilize, in real-time, images from the rear-view camera 106 to identify and/or detect one or more trailer components within the images. According to an exemplary embodiment, identifying the one or more trailer components may comprise generating a bounding box for each of a trailer front, a trailer bottom, a coupler frame, a coupler, a jackstand, and/or other suitable trailer components. According to an exemplary embodiment, identifying and/or detected the one or more trailer components may comprise determining a relative position of the one or more trailer components in relation to the hitch of the towing vehicle. According to an exemplary embodiment, identifying the one or more trailer components may comprise capturing the one or more images. The one or more images may be captured using the rear-view camera of the vehicle.

According to an exemplary embodiment, the computing device of the vehicle may be configured to generate a path planner. According to an exemplary embodiment, the path planner may require a “Path Target Point” as a final destination of a path originating from the hitch (e.g., the hitch ball).

At 204, it may be determined whether a coupler has been detected. When a coupler is detected (typically at close distances), the path planner, at 206, may utilize the centroid of the coupler's bounding box as the Path Target Point to formulate the trajectory of the towing vehicle. Using the Path Target Point, at 230, path planning to the Path Target Point may be generated.

According to an exemplary embodiment, when a coupler is not detected, it may be determined, at 208, whether a coupler frame has been detected. When a coupler frame is not detected, then, at 210, it may be determined whether a jackstand has been detected.

When the coupler frame and/or jackstand is not detected, it may be determined, at 212, whether at least one trailer component has been detected. When at least one trailer component has not been detected, then, at 202, the perception model may utilize, in real-time, images from the rear-view camera 106 to identify and/or detect one or more trailer components within the images.

When at least one trailer component has been detected, then, at 214, the centroid of a trailer component may be set as the Path Target Point according to the following priority: trailer front<trailer bottom<coupler frame. After the Path Target Point is set, then, at 230, path planning to the Path Target Point may be generated.

When both the coupler frame and the jackstand are detected, it may be determined, at 216, whether the bounding box of the coupler frame and the bounding box of the jackstand intersect.

When the bounding box of the coupler frame and the bounding box of the jackstand do not intersect, then, at 218, it may be determined whether the jackstand is under the coupler frame. When the jackstand is not under the coupler frame, then, at 214, the centroid of a trailer component may be set as the Path Target Point according to the following priority: trailer front<trailer bottom<coupler frame.

When the jackstand is under the coupler frame, then, at 220, the bounding box of the jackstand may be extended vertically to reach the bounding box of the coupler frame and it may be determined, at 216, whether the bounding box of the coupler frame and the bounding box of the jackstand intersect.

When the bounding box of the coupler frame and the bounding box of the jackstand do intersect, then, at 222, an intersection area or line of the bounding box of the jackstand and the bounding box of the coupler frame may be identified.

At 224, the centroid of the intersection area or middle of the intersection line may be set as a starting point (P₁) of a trailer coupler approximation bounding box. At 226, a width and the height of the trailer coupler approximation bounding box may be calculated based on a relative position of P₁ with respect to the bounding box of the coupler frame.

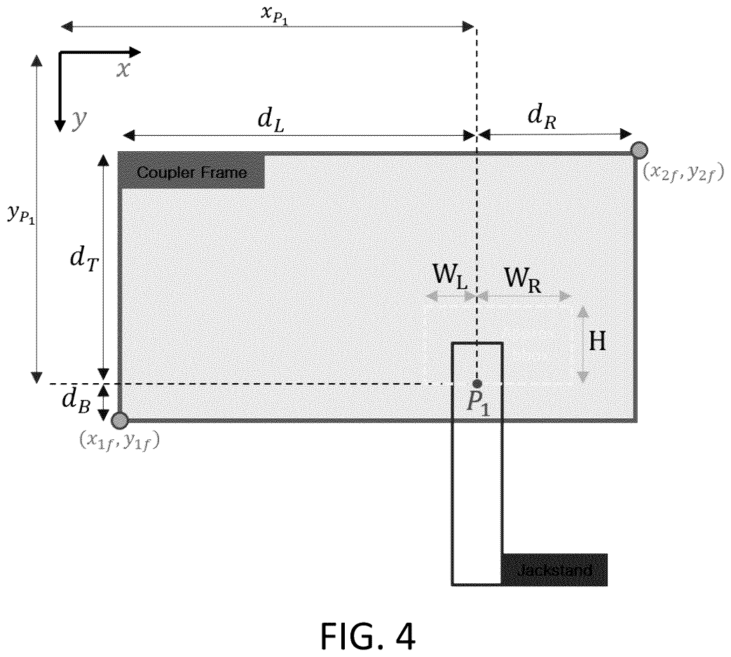

According to an exemplary embodiment, and as shown, e.g., in FIG. 4, using the relative position of P₁ with respect to the coupler frame, the left and right widths (W_{L} and W_{R}) and a height (H) may be calculated to construct the trailer coupler approximation bounding box.

A weighted lateral and vertical gains for P₁ may be calculated according to Equation 1, Equation 2, and Equation 3

$${G}_{L} = \frac{{d}_{L}}{{d}_{R} + {d}_{L}} \qquad Equation 1$$

$${G}_{R} = \frac{{d}_{R}}{{d}_{R} + {d}_{L}} \qquad Equation 2$$

$${G}_{H} = \frac{{d}_{T}}{{d}_{T} + {d}_{B}} \qquad Equation 3$$

According to an exemplary embodiment, the widths and the height may be calculated according to Equation 4, Equation 5, and Equation 6.

$$\begin{matrix}{W}_{L} = min ( {d}_{L} , α {d}_{R}^{β} {G}_{R} ) , where 0 < α < 1 and β is a constant & Equation 4\end{matrix}$$

$${W}_{R} = min ( {d}_{R} , α {d}_{L}^{β} {G}_{L} ) , where 0 < α < 1 and β is a constant \qquad Equation 5$$

$$H = γ {d}_{T} {( {G}_{H} )}^{δ} , where 0 < γ < 1 and δ is a constant \qquad Equation 6$$

According to an exemplary embodiment, W_{L} and W_{R} may be saturated by d_{L} and d_{R}, respectively, so that the trailer coupler approximation bounding box is ensured to be enclosed within the coupler frame bounding box.

For example, if d_{L}=d_{R}, then

$${W}_{L} = {W}_{R} = 0.5 α {d}_{L}^{β} = 0.5 α {d}_{R}^{β} ,$$

and the approximated coupler location is at the middle of the coupler frame bounding box.

The formula for H ensures that the trailer coupler approximation bounding box starts with a height of γ*d_{T} when P₁ touches the lower side of the coupler frame (d_{B}=0). Height H will converge to zero as P₁ reaches the top side of the coupler frame (d_{T}=0).

At 228, the centroid of the trailer coupler approximation bounding box may then be set as the Path Target Point and, once the Path Target Point is set, then, at 230, path planning to the Path Target Point may be generated.

According to an exemplary embodiment, generating the path planning may comprise constructing a path from the hitch to the set/established Path Target Point.

Then, at 232, an autonomous vehicle (AV) maneuver using the planned path may be implement in which the vehicle automatically executes acceleration and steering maneuvers to adhere to this path. At 234, it may be determined whether the vehicle is hitched to the trailer (i.e., the hitch is coupled to the trailer coupler) and the method. According to an exemplary embodiment, the method 200 may be repeated until the hitch is within a predefined error distance threshold from the trailer coupler.

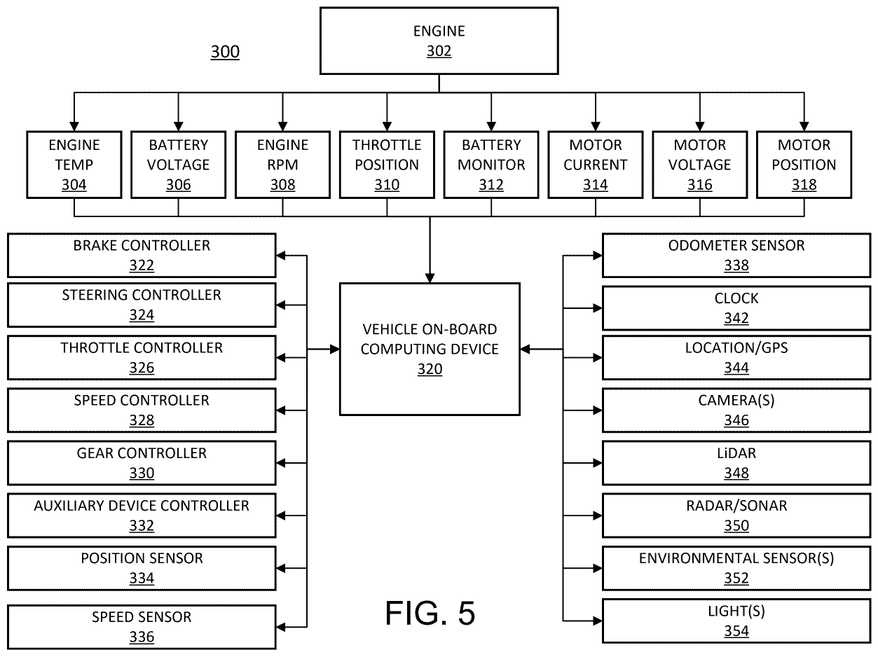

Referring now to FIG. 5, an example vehicle system architecture 300 for a vehicle is provided, in accordance with an exemplary embodiment of the present disclosure. The following discussion of vehicle system architecture 300 is sufficient for understanding one or more components of vehicle 102.

As shown in FIG. 5, the vehicle system architecture 300 may comprise an engine, motor or propulsive device 302 and various sensors 304-318 for measuring various parameters of the vehicle system architecture 300, such as, but not limited to, those of the vehicle snapshot described above. In gas-powered or hybrid vehicles having a fuel-powered engine, the sensors 304-318 may comprise, for example, an engine temperature sensor 304, a battery voltage sensor 306, an engine Rotations Per Minute (RPM) sensor 308, and/or a throttle position sensor 310. If the vehicle is an electric or hybrid vehicle, then the vehicle may comprise an electric motor, and accordingly may comprise sensors such as a battery monitoring system 312 (to measure current, voltage and/or temperature of the battery), motor current 314 and voltage 316 sensors, and motor position sensors such as resolvers and encoders 318.

Operational parameter sensors that are common to both types of vehicles may comprise, for example: a position sensor 334 such as an accelerometer, gyroscope and/or inertial measurement unit; a speed sensor 336; and/or an odometer sensor 338. The vehicle system architecture 300 also may comprise a clock 342 that the system uses to determine vehicle time and/or date during operation. The clock 342 may be encoded into the vehicle on-board computing device 320, it may be a separate device, or multiple clocks may be available.

The vehicle system architecture 300 may comprise various sensors that operate to gather information about the environment in which the vehicle is traveling. These sensors may comprise, for example: a location sensor 344 (for example, a Global Positioning System (GPS) device); object detection sensors such as one or more cameras 346; a LIDAR sensor system 348; and/or a radar and/or a sonar system 350. The sensors may comprise environmental sensors 352 such as, e.g., a humidity sensor, a precipitation sensor, a light sensor, and/or ambient temperature sensor. The object detection sensors may be configured to enable the vehicle system architecture 300 to detect objects that are within a given distance range of the vehicle in any direction, while the environmental sensors 352 may be configured to collect data about environmental conditions within the vehicle's area of travel. According to an exemplary embodiment, the vehicle system architecture 300 may comprise one or more lights 354 (e.g., headlights, flood lights, flashlights, etc.).

During operations, information may be communicated from the sensors to an on-board computing device 320 (e.g., computing device 108). The on-board computing device 320 may be configured to analyze the data captured by the sensors and/or data received from data providers and may be configured to optionally control operations of the vehicle system architecture 300 based on results of the analysis. For example, the on-board computing device 320 may be configured to control: braking via a brake controller 322; direction via a steering controller 324; speed and acceleration via a throttle controller 326 (in a gas-powered vehicle) or a motor speed controller 328 (such as a current level controller in an electric vehicle); a differential gear controller 330 (in vehicles with transmissions); and/or other controllers. The brake controller 322 may comprise a pedal effort sensor, pedal effort sensor, and/or simulator temperature sensor, as described herein.

Geographic location information may be communicated from the location sensor 344 to the on-board computing device 320, which may then access a map of the environment that corresponds to the location information to determine known fixed features of the environment such as streets, buildings, stop signs and/or stop/go signals. Captured images from the cameras 346 and/or object detection information captured from sensors such as LiDAR 348 may be communicated from those sensors to the on-board computing device 320. The object detection information and/or captured images may be processed by the on-board computing device 320 to detect objects in proximity to the vehicle. Any known or to be known technique for making an object detection based on sensor data and/or captured images may be used in the embodiments disclosed in this document.

Referring now to FIG. 8, an illustration of an example architecture for a computing device 400 is provided. According to an exemplary embodiment, one or more functions of the present disclosure may be implemented by a computing device such as, e.g., computing device 400 or a computing device similar to computing device 400. Computing device 400 may be a quantum computer, a classical computer, and/or have one or more components configured to perform one or more quantum and/or classical computing functions. Computing device 136 and/or computing device 320 may be an example of computing device 400 and/or may comprise one or more components of computing device 400.

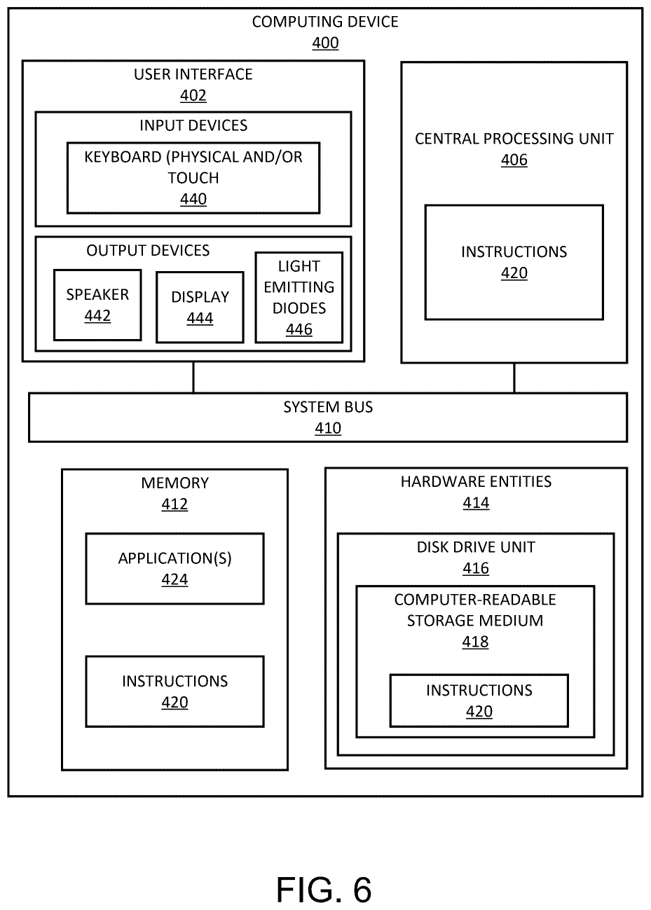

The hardware architecture of FIG. 6 represents one example implementation of a representative computing device configured to implement at least a portion of the systems/devices (e.g., vehicle 102) and method(s)/control logic(s) (e.g., method 200) described herein.

Some or all components of the computing device 400 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 6, the computing device 400 may comprise a user interface 402 (e.g., a graphical user interface), a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which may be configured to facilitate user-software interactions for controlling operations of the computing device 400. The input devices may comprise, but are not limited to, a physical and/or touch keyboard 440. The input devices may be connected to the computing device 400 via a wired or wireless connection (e.g., a Bluetooth® connection). The output devices may comprise, but are not limited to, a speaker 442, a display 444, and/or light emitting diodes 446.

At least some of the hardware entities 414 may be configured to perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which may be stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400.

The memory 412 and the CPU 406 may also constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding, or carrying a set of instructions 420 for execution by the computing device 400 and that cause the computing device 400 to perform any one or more of the methodologies of the present disclosure. According to various embodiments, one or more computer applications 424 may be stored on the memory 412.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed,

What is claimed is:

1. A method for performing trailer coupler location approximation, comprising:
i) identifying a jackstand and coupler frame of a trailer within an image;
ii) determining a path target point based on image; and
iii) constructing a path from a hitch of a vehicle to the path target point.

2. A method for performing trailer coupler location approximation, comprising:
a) identifying, using a computing device comprising a processor and a memory, a jackstand and coupler frame of a trailer within an image;
b) defining a bounding box for the jackstand and a bounding box for the coupler frame;
c) setting an intersection between the bounding box for the jackstand and the bounding box for the coupler frame as a starting point for an approximation bounding box for a trailer coupler;
d) setting a centroid of the approximation bounding box for the trailer coupler as a path target point; and
e) constructing a path from a hitch of a vehicle to the path target point.

3. The method of claim 2, further comprising, prior to setting the centroid of the approximation bounding box for the trailer coupler as the path starting point, calculating dimensions of the approximation bounding box for the trailer coupler with respect to the bounding box for the coupler frame.

4. The method of claim 2, further comprising performing an autonomous vehicle (AV) maneuver according to the path, comprising automatically executing acceleration and steering maneuvers to cause the vehicle to adhere to the path.

5. The method of claim 4, further comprising, after performing the AV maneuver, determining whether the hitch is positioned within a predefined error distance threshold from the trailer coupler.

6. The method of claim 2, wherein:
the intersection comprises an intersection area, and
the starting point comprises a centroid of the intersection area.

7. The method of claim 2, wherein:
the intersection comprises an intersection line, and
the starting point comprises a middle point of the intersection line.

8. The method of claim 2, further comprising, when there is not an intersection between the bounding box for the jackstand and the bounding box for the coupler frame, determining whether the jackstand is positioned under the coupler frame.

9. The method of claim 8, further comprising, when there is not an intersection between the bounding box for the jackstand and the bounding box for the coupler frame and the jackstand is under the coupler frame, extending the bounding box of the jackstand vertically until the bounding box for the jackstand reaches the bounding box of the coupler frame.

10. The method of claim 2, wherein the identifying the jackstand and coupler frame within the image comprises capturing the image, using a rear-view camera of the vehicle.

11. The method of claim 2, wherein the identifying the jackstand and coupler frame within the image comprises determining a relative position of the one or more trailer components to the hitch.

12. The method of claim 2, wherein the identifying the jackstand and coupler frame within the image comprises:
determining whether the jackstand has been detected within an image; and
determining whether the coupler frame has been detected within an image.

13. A method of claim 1, comprising:
a) identifying, using a computing device comprising a processor and a memory, a jackstand and coupler frame of a trailer within an image;
b) defining a bounding box for the jackstand and a bounding box for the coupler frame;
c) determining whether there is an intersection between the bounding box for the jackstand and the bounding box for the coupler frame;
d) when there is an intersection between the bounding box for the jackstand and the bounding box for the coupler frame, finding the intersection between the bounding box for the jackstand and the bounding box for the coupler frame;
e) setting the intersection as a starting point for an approximation bounding box for a trailer coupler;
f) calculating dimensions of the approximation bounding box for the trailer coupler with respect to the bounding box for the coupler frame;
g) setting a centroid of the approximation bounding box for the trailer coupler as a path target point; and
h) constructing a path from a hitch of a vehicle to the path target point.

14. A system for performing trailer coupler location approximation, comprising:
A) a vehicle, comprising:
i) a rear-view camera;
ii) a hitch; and
B) a computing device, comprising a processor and a memory, wherein the memory is configured to store instructions that, when executed by the processor, are configured to cause the processor to perform steps comprising:
i) identify a jackstand and coupler frame of a trailer within an image;
ii) determine a path target point based on image; and
iii) construct a path from a hitch of a vehicle to the path target point.

15. The system of claim 14 wherein instructions that, when executed by the processor, are configured to cause the processor to perform steps comprising:
a) identify a jackstand and coupler frame of a trailer within an image;
b) define a bounding box for the jackstand and a bounding box for the coupler frame;
c) set an intersection between the bounding box for the jackstand and the bounding box for the coupler frame as a starting point for an approximation bounding box for a trailer coupler;
d) set a centroid of the approximation bounding box for the trailer coupler as a path target point; and
e) construct path from a hitch of a vehicle to the path target point.

16. The system of claim 15, wherein the instructions, when executed by the processor, are further configured to cause the processor to perform an autonomous vehicle (AV) maneuver according to the path, comprising automatically executing acceleration and steering maneuvers to cause the vehicle to adhere to the path.

17. The system of claim 16, wherein the instructions, when executed by the processor, are further configured to cause the processor to, after performing the AV maneuver, determine whether the hitch is positioned within a predefined error distance threshold from the trailer coupler.

18. The system of claim 15, wherein the instructions, when executed by the processor, are further configured to cause the processor to, when there is not an intersection between the bounding box for the jackstand and the bounding box for the coupler frame, determine whether the jackstand is positioned under the coupler frame.

19. The system of claim 18, wherein the instructions, when executed by the processor, are further configured to cause the processor to, when there is not an intersection between the bounding box for the jackstand and the bounding box for the coupler frame and the jackstand is under the coupler frame, extend the bounding box of the jackstand vertically until the bounding box for the jackstand reaches the bounding box of the coupler frame.

20. The system of claim 15, wherein the identifying the jackstand and coupler frame within the image comprises:
determining whether the jackstand has been detected within an image; and
determining whether the coupler frame has been detected within an image.
